(19) United States
(12) Patent Application Publication
(10) Pub. No.: US 2024/0135405 A1
(43) Pub. Date: Apr. 25, 2024

(54) MULTI-DIGITAL INCENTIVE SELECTION WITH A USER-SPECIFIC CODE

(71) Applicant: CATALINA MARKETING CORPORATION, St. Petersburg, FL (US)

(72) Inventors: Zubin Singh, San Jose, CA (US); Tony Mou, St. Petersburg, FL (US); Julie Valdez, St. Petersburg, FL (US); Kirk Dikun, Tampa, FL (US); Todd Schramek, St. Petersburg, FL (US); Ryan Monahan, Orange, CA (US); Kevin Hunter, La Jolla, CA (US)

(21) Appl. No.: 18/279,036

(22) PCT Filed: Feb. 25, 2022
(86) PCT No.: PCT/US2022/017820

§ 371 Date: Aug. 24, 2023

Related U.S. Application Data
(60) Provisional application No. 63/154,580, filed on Feb. 26, 2021.

(51) Int. Cl. G06Q 30/0207; G06K 19/06; G06Q 30/0241

(52) U.S. Cl. CPC G06Q 30/0224; G06K 19/06037; G06Q 30/0277

(57) ABSTRACT

A method for redeeming multiple digital offers with a digital code is provided. The method includes retrieving one or more consumer identification values, forming an offer for the consumer, the offer including a digital incentive associated with a product or service of interest for the consumer, and creating, in a persistent record, an offer monitor to update the offer for the consumer and include the offer, the offers associated with multiple products and services of interest for the consumer. The persistent record includes multiple offers for the consumer and is stored at a network address associated with the consumer. The method also includes associating a digital code with the persistent record, and integrating the persistent record with a wallet application installed in the user device. A system and a non-transitory, computer-readable medium storing instructions to cause the system to perform the above method are also provided.

### CROSS-REFERENCE TO RELATED APPLICATIONS

The present disclosure is related to and claims priority under the PCT to U.S. Prov. Appln. No. 63/154,580, entitled “MULTI-DIGITAL INCENTIVE SELECTION WITH A USER-SPECIFIC CODE,” to Singh, et-al, filed on Feb. 26, 2021, the contents of which are hereby incorporated by reference in their entirety, for all purposes.

### BACKGROUND

### Field

The present disclosure is related to storing multiple targeted digital payloads personalized for a consumer at a network address. More specifically, the present disclosure is directed to associating a booklet of personalized digital coupons, product offers, and incentives personalized to a consumer, and storing at a network address accessible by the consumer via a user specific, persistent and virtualized quick response code, pin code, or barcode, more generally referenced as a code or digital code scanned at a point-of-sale (POS) or retailer store.

### Brief Background Description

In the existing world of paper and digital promotions, many applications and modalities exist that enable a consumer to access product offers, value added offers, coupons, and deals from different retailers and product manufacturers. Typically, each of these offers carries its own identification codes, forcing the consumer to scroll and carry multiple codes associated with promotions to a retailer for activation at a retailer's POS system. This causes confusion and frustration amongst consumers as to which offer to use at a particular retailer and also results in the point-of-sale attendant participating with the customer to help find and attempt to activate the right offer for the product being purchased. This all amounts to other customers in the checkout line being delayed and generally is not a pleasing experience for all parties.

### BRIEF DESCRIPTION OF THE DRAWINGS

FIG. 1 illustrates an example architecture suitable for providing a multi-digital incentive selection with a user-specific code, according to some embodiments.

FIG. 2 is a block diagram illustrating an example server and client from the architecture of FIG. 1, according to certain aspects of the disclosure.

FIG. 3 illustrates an architecture for implementing some of the embodiments disclosed herein.

FIG. 4 illustrates a sequence of steps and actions in a system as illustrated in the architectures of FIGS. 1 and 3, according to some embodiments.

FIG. 5 illustrates a landing webpage in a desktop application to access an offer booklet for a consumer, according to some embodiments.

FIGS. 6A-6E illustrate some of the digital coupons, product offers, or incentives selected by a consumer from a personalized booklet accessed via a mobile wallet application, according to some embodiments.

FIG. 7 illustrates a digital payload selected by a consumer from a personalized booklet accessed via a mobile wallet application, according to some embodiments.

FIG. 8 is a flow chart illustrating steps in a method for accessing multiple, personalized digital offers for a consumer and redeeming such offers using a single digital code, according to some embodiments.

FIG. 9 is a flow chart illustrating steps in a method for accessing a booklet of personalized digital coupons, product offers, and incentives for a consumer using a mobile device, according to some embodiments.

FIG. 10 is a block diagram illustrating an example computer system with which the client and server of FIGS. 1 and 2 and the methods of FIGS. 8 and 9 can be implemented.

In the figures, elements and steps denoted by the same or similar reference numerals are associated with the same or similar elements and steps, unless indicated otherwise.

### SUMMARY

In a first embodiment, a computer-implemented method includes retrieving, in a server and from an identification map in a database, one or more consumer identification values, wherein a consumer has received, in a user device, an advertisement payload from a multimedia network publisher, and has clicked on the advertisement payload. The computer-implemented method also includes forming an offer for the consumer, the offer including a digital incentive associated with a product or service of interest for the consumer, and creating, in a persistent record, an offer monitor to update the offer for the consumer and include the offer, the offers associated with multiple products and services of interest for the consumer, wherein the persistent record includes multiple offers for the consumer and is stored at a network address associated with the consumer, and associating a digital code with the persistent record, the digital code configured for display in the user device and for recognition by a scanner to apply to multiple offers for the consumer in the advertisement payload at a point-of-sale of multiple retailer stores. The computer-implemented method also includes integrating the persistent record with a wallet application installed in the user device.

In a second embodiment, a computer-implemented method, includes accessing, in a client device, a mobile wallet application, activating a passcode to access an offer booklet, and selecting, from the offer booklet, a first offer to load in the mobile wallet application, the first offer associated with a first product. The computer-implemented method also includes selecting, from the offer booklet, a second offer to load in the mobile wallet application, the second offer associated with a second product, activating a digital code from the offer booklet, and presenting the digital code at a point-of-sale for a first retailer carrying the first product or the second product to redeem at least one of the first offer and the second offer.

In a third embodiment, a system includes one or more processors and a memory storing instructions which, when executed by the processors, cause the system to perform operations including: to retrieve, in a server and from an identification map in a database, one or more consumer identification values, wherein a consumer has received, in a user device, an advertisement payload from a multimedia network publisher, and has clicked on the advertisement payload. The operations also include to form an offer for the consumer, the offer including a digital incentive associated with a product or service of interest for the consumer, and to create, in a persistent record, an offer monitor to update the offer for the consumer and include the offer, the offers associated with multiple products and services of interest for the consumer, wherein the persistent record includes multiple offers for the consumer and is stored at a network address associated with the consumer. The operations also include to associate a digital code with the persistent record, the digital code configured for display in the user device and for recognition by a scanner to apply to multiple offers for the consumer in the advertisement payload at a point-of-sale for multiple retailer stores; and to integrate the persistent record with a wallet application installed in the user device.

In yet other embodiment, a system includes a first means to execute instructions, and a second means to execute the instructions, to cause the system to perform a method, including retrieving, in a server and from an identification map in a database, one or more consumer identification values, wherein a consumer has received, in a user device, an advertisement payload from a multimedia network publisher, and has clicked on the advertisement payload. The method also includes forming an offer for the consumer, the offer including a digital incentive associated with a product or service of interest for the consumer, and creating, in a persistent record, an offer monitor to update the offer for the consumer and include the offer, the offers associated with multiple products and services of interest for the consumer, wherein the persistent record includes multiple offers for the consumer and is stored at a network address associated with the consumer. The method also includes associating a digital code with the persistent record, the digital code configured for display in the user device and for recognition by a scanner to apply to multiple offers for the consumer in the advertisement payload at a point-of-sale of multiple retailer stores, and integrating the persistent record with a wallet application installed in the user device.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

Consumers like to have one or more personalized digital coupons, product offers, and incentives consolidated in a single digitized booklet having automated access via a mobile wallet application installed in a mobile device. It is preferable that the one or more digital coupons, product offers, and incentives could be redeemable for any assortment of products at one or more different retail stores, and be of direct and easy access such that the consumer may not remember a specific code to redeem the digital coupons, product offers, and incentives. In some embodiments, a single digital code scanned at a POS suffices for the user to access digital coupons, product offers, and an incentives booklet that is persistent and is continuously updated by a remote server with new and more attractive digital coupons, product offers, and incentives.

Embodiments as disclosed herein provide tools and techniques to implement a digital code to provide direct access to personalized digital coupons, product offers, and an incentives booklet for a consumer. The system may run software as a service (SaaS) in a native application (e.g., a web browser application) of a consumer mobile device, such that the consumer may not need to use a password or code to access the booklet of digital coupons, product offers, and incentives. Moreover, one digital code may be used to carry multiple product digital coupons, product offers, and incentives from different manufacturers and retailers, and the user may hop from one store to the next simply scanning the same digital code at the POS.

Some embodiments implement digital gift card and virtual credit card technology to create the code or digital code that may be run in a mobile wallet application and scanned at multiple retail locations, and a POS to redeem one or more personalized digital coupons, product offers, and incentives from a booklet using a mobile device to display the virtualized digital code. In yet other embodiments, the digital code may include an audio signal, e.g., an ultrasound code that may be recognized by a scanner at the POS, or a near field coupling (NFC) or tapping coupling using electric, magnetic, or electromagnetic coding to redeem the digital offers for the consumer.

### Example System Architecture

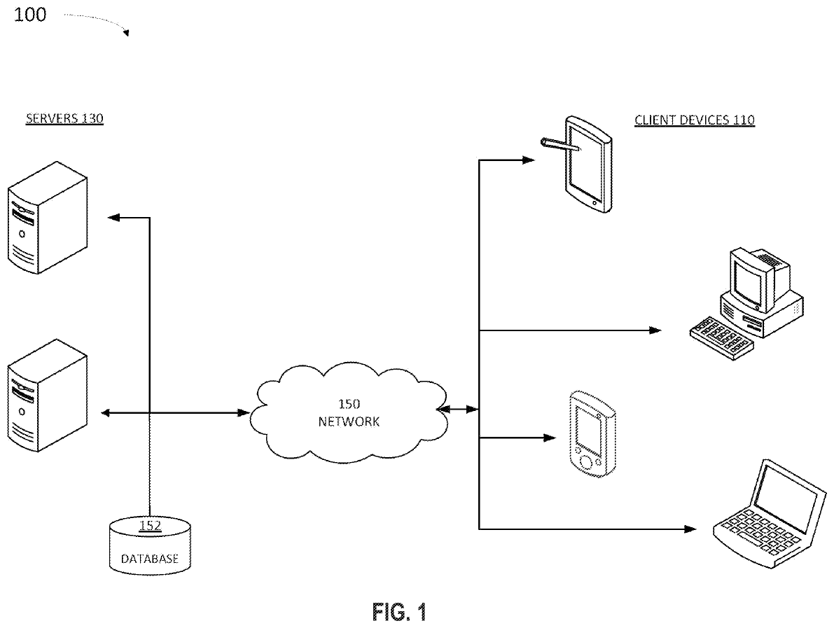

FIG. 1 illustrates an example architecture 100 for a multi-digital incentive engine suitable for practicing some implementations of the disclosure. Architecture 100 includes servers 130 and client devices 110 coupled over a network 150. One of servers 130 is configured to host a memory, including instructions which, when executed by a processor, cause the server 130 to perform at least some of the steps in methods as disclosed herein. In some embodiments, architecture 100 is configured to provide an advertisement payload to a consumer, who may be the user of client device 110. In some embodiments, a client device 110 may be a point-of-sale (POS) device communicatively coupled with server 130, with which a consumer may scan a digital code (e.g., a barcode, a Quick Readout—QR—code, and the like). The advertisement payload may include multiple targeted digital promotions collected from a purchase history of the consumer, which may be stored in a history log in a memory of the server or in a database 152, and accessible to the consumer via a digital code.

Servers 130 may include any device having an appropriate processor, memory, and communications capability for hosting the history log, a digital promotion database, an advertising technology server, a multi-digital incentive engine, and an advertising engine. The multi-digital incentive engine and the advertising engine may be accessible by one or more client devices 110 over network 150. In some embodiments, servers 130 may include a dynamic creative rendering server, a publisher, or supply side platform (SSP) server, and a demand side platform (DSP) server. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing multi-digital incentive engine or advertising engine 240, and the history log on one or more of servers 130. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

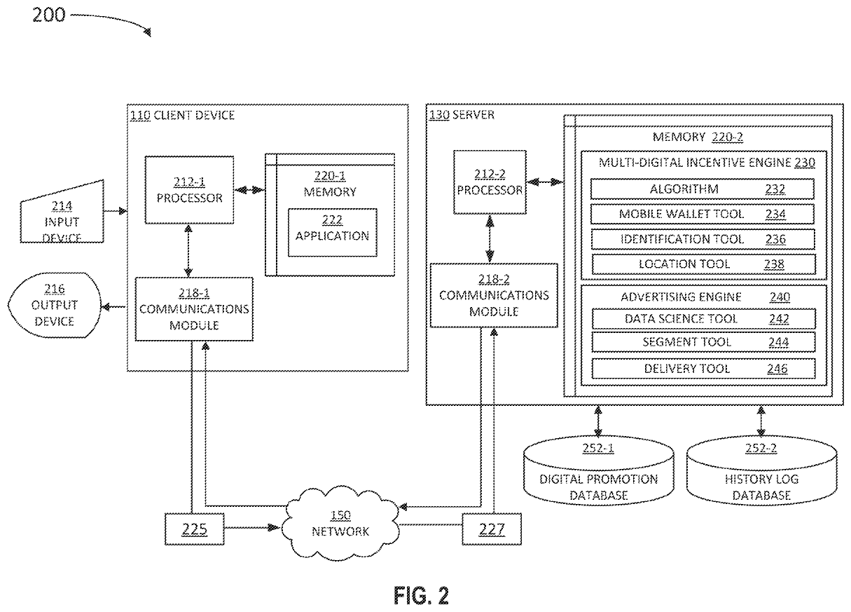

FIG. 2 is a block diagram 200 illustrating an example server 130 and client device 110 (cf. architecture 100), according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices on the network. Communications modules 218 can be, for example, modems or Ethernet cards. Client device 110 may be coupled with an input device 214 and with an output device 216. Input device 214 may include a keyboard, a mouse, a pointer, a scanner (e.g., a barcode scanner), or even a touch-screen display that a consumer may use to interact with client device 110. Likewise, output device 216 may include a display and a speaker with which the consumer may retrieve results from client device 110. Client device 110 may also include a processor 212-1, configured to execute instructions stored in a memory 220-1, and to cause client device 110 to perform at least some of the steps in methods consistent with the present disclosure. Memory 220-1 may further include an application 222. Application 222 includes specific instructions which, when executed by processor 212-1, cause a client device 110 to provide a digital code 225 to server 130. In response, server 130 may provide a digital promotion payload 227 to be displayed for the consumer in output device 216. Digital promotion payload 227 may include multiple digital promotions or coupons presented to the consumer by server 130, and the consumer may store at least some of the digital promotions or coupons from digital promotion payload 227 in memory 220-1.

In some embodiments, application 222 may include a mobile wallet application, configured to store one or more value offers (e.g., a coupon, a discount, and the like), which has been selected (e.g., “clipped”) by the consumer from any one of the multiple digital promotions or coupons in digital promotion payload 227. Further, in some embodiments, a mobile wallet application may associate the value offer selected by the consumer to a frequent shopper ID (FSC-ID) for a retailer. Application 222 may be installed in memory 220-1 by the manufacturer, retailer, advertising server, or a server handling multi-digital incentives, together with the installation of an operating system that controls all hardware operations of client device 110. Moreover, in some embodiments, a consumer may download a retailer application in client device 110 from the retailer. The consumer may have an FSC-ID associated with application 222. In some embodiments, in addition to one or more “brick and mortar” physical locations of stores for the retailer, the retailer may host an online shopping outlet hosted by a network server (e.g., server 130).

Server 130 includes a memory 220-2, a processor 212-2, and a communications module 218-2. Processor 212-2 is configured to execute instructions, such as instructions physically coded into processor 212-2, instructions received from software in memory 220-2, or a combination of both. Memory 220-2 includes a multi-digital incentive engine 230, configured to identify and correlate digital code 225 with a consumer and promotion payload 227 by accessing a digital promotion database 252-1. To do this, multi-digital incentive engine 230 may include an algorithm 232, a mobile wallet tool 234, an identification tool 236, and a location tool 238. When the user provides digital code 225, multi-digital incentive engine 230 may direct a server 130 associated with advertising or with a retailer to prepare, update, and transmit digital promotion payload 227. Advertising engine 240 may push digital promotions from digital promotion database 252-1 to a consumer of client device 110 that is a consumer of a retailer store or chain of stores through application 222 or a web browser installed in client device 110. Accordingly, application 222 may be installed by server 130 and perform scripts and other routines provided by server 130. In some embodiments, at least one of application 222 may be configured to display digital promotion payload 227 provided by an ad creative server. In some embodiments, digital code 225 may include a client device identifier, or a user identifier in a network hosted by server 130.

Algorithm 232 may include a linear regression algorithm, or a non-linear regression algorithm. In some embodiments, algorithm 232 may include a neural network (NN) or a derivative thereof, such as a convolutional neural network (CNN), a deep learning neural network (DLNN), a generative adversarial network (GAN), and the like. In some embodiments, the NN in algorithm 232 is a supervised NN with human defined classifiers, or an unsupervised NN with un-specified classifiers. In some embodiments, algorithm 232 may include a machine learning algorithm or an artificial intelligence algorithm. Mobile wallet tool 234 is configured to provide, update, and manage a mobile wallet application available to a consumer via application 222 (e.g., a mobile wallet application). Identification tool 236 determines the identity of the consumer based on digital code 225. Location tool 238 determines the current location of the consumer based on a device identifier for client device 110, or accessing data in a geolocation application or other location applications running in client device 110 (e.g., application 222). Accordingly, the location data obtained by location tool 238 may also be used by identification tool 236 to further confirm the identity of a consumer handling client device 110.

Digital promotion payload 227 is integrated based on information retrieved from a digital promotion database 252-1 and a history log database 252-2 (hereinafter, collectively referred to as “databases 252”). History log database 252-2 includes the purchase history of multiple consumers listed in digital promotion database 252-1. To achieve this, in some embodiments, a data science tool 242 stores commands which, when executed by processor 212-2, causes server 130 to integrate digital promotion payload 227. In some embodiments, a segment tool 244 may split a universe of consumers into different segments based on demographic data, and associate different consumer behaviors, preferences, and products most likely to purchase for each of the consumer segments. Accordingly, segment tool 244 may also collaborate with data science tool 242 to generate digital promotion payload 227. Data science tool 242 and/or segment tool 244 may include a neural network (NN) trained over databases 252, to select digital promotion payload 227 targeted to the specific preferences of a consumer when the consumer grants application 222 to track user transactions. A delivery tool 246 provides the addresses and multimedia resources for digital promotion payload 227. Accordingly, delivery tool 246 may be configured to integrate images, videos, and other multimedia files from a digital promotion database 252-1 into digital promotion payload 227.

In one or more implementations, digital promotion database 252-1 integrates digital promotion payloads 227 including coupons and digital promotions for multiple products on sale by a retailer having one or more stores. Digital promotion database 252-1 may include a list of frequent consumers of one or more retailer or brand manufacturer. The retailer or manufacturer may create, update, and maintain databases 252. In that regard, databases 252 may be hosted by a DSP server or a dynamic creative rendering server. Accordingly, the DSP server may have access to one or more databases 252 through business agreements with one or more retailers.

In certain aspects, processor 212-2 in a server 130 is configured to collect data for history log database 252-2 by obtaining consumer purchasing data identifying the consumer via the frequent shopper identification used at multiple purchasing events in multiple locations, over a pre-selected span of time. In some embodiments, history log database 252-2 includes online purchasing history for the consumer through application 222 or a network browser. Processors 212-1 and 212-2 will be collectively referred, hereinafter, as “processors 212.” Memories 220-1 and 220-2 will be collectively referred, hereinafter, as “memories 220.”

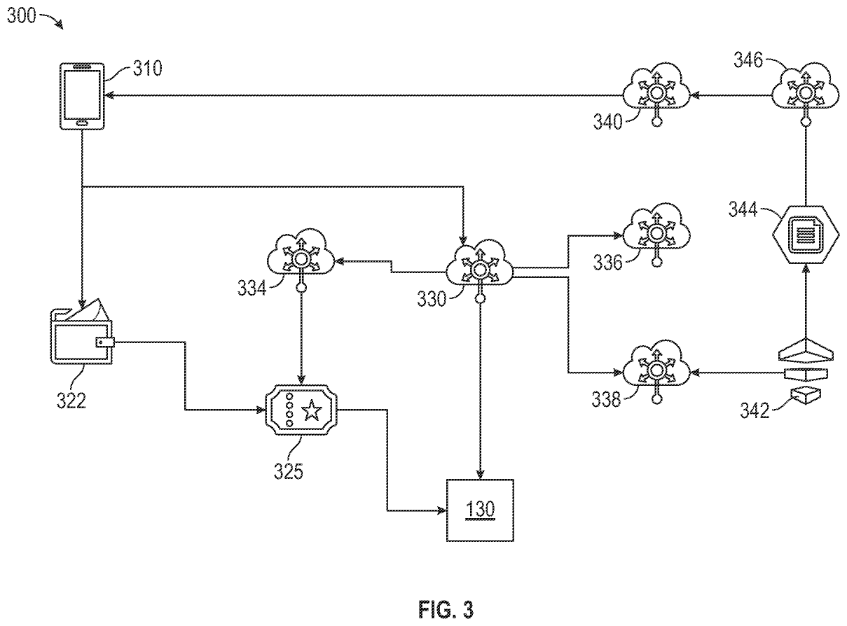

FIG. 3 illustrates an architecture 300 for implementing some of the embodiments disclosed herein. A native mobile wallet application 322 is included as a part of the native device manufacturers operating system and is running in a mobile device 310 used by a consumer. A wallet entry 325 in mobile wallet application 322 may include a digital coupon, product offer, or incentive for a product provided by a server portal 130, among other digital services 330. In some embodiments, digital services 330 may include a mobile wallet pass or card generator 334 that triggers when the consumer clicks on an advertisement provided by a digital programmatic advertising server 340 being referenced by mobile device 310. Server portal 130 may also couple with an identity graph (e.g., identity map, or identity tool) 336 that contains user identity linkages to correlate the user of mobile device 310 with a consumer in the network of server portal 130 that links to a retailer's loyalty card identity.

Other features and elements in the architecture may include a digital advertisement addressable audience segment server 344 and segment delivery server 346, that prepare and deliver personalized audiences to programmatic advertisement server 340. The personalized audience or segments are linked to advertisements for consumers based on purchasing history and other data stored in one or more databases (e.g., databases 252) controlled by a data science server 342. Additionally, a location application programming interface (API) 338 may provide information as to the precise location of mobile device 310 to programmatic advertising server 340, so as to prepare targeted digital coupons, product offers, or incentives, or activate appropriate digital coupons, product offers, or incentives based on a retailer where the consumer is located (e.g., provide for redemption items that are available for purchase at a selected location).

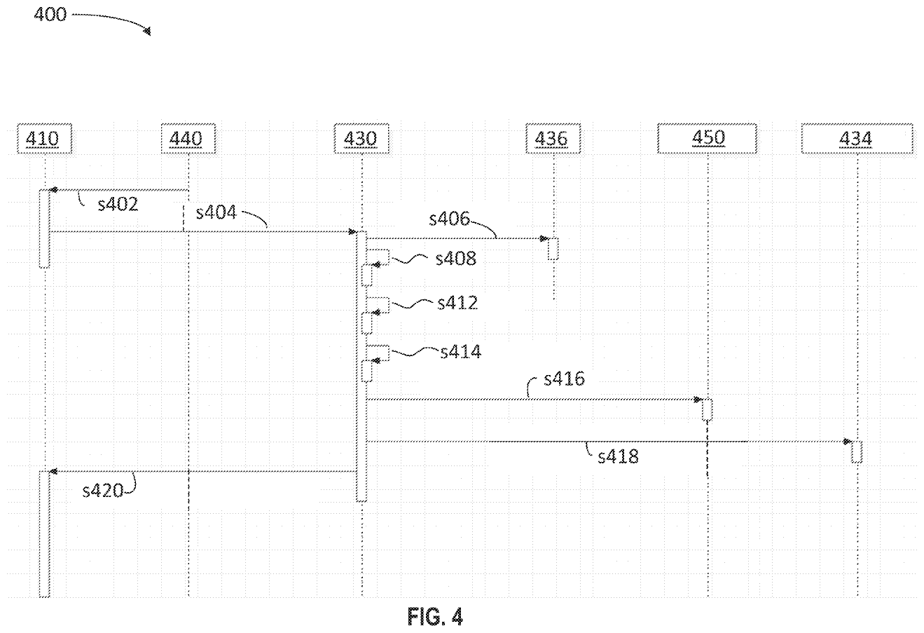

FIG. 4 illustrates a sequence 400 of steps and actions in a system as illustrated in architectures 100 or 300, according to some embodiments. The system may include a consumer handling a mobile device 410, a digital advertisement unit 440 providing advertisement payloads to mobile device 410, a server 430 having access to an identity graph (e.g., identity graph or identity tool) 436, a digital gift card or virtual credit card provider (e.g., card provider) 450 that provides a digital code to enable digital coupons, product offers, or incentives and the dollar amounts to be discounted or applied after scanning at a POS terminal, and a wallet integration API 434.

In s402, advertisement unit 440 provides the advertisement payload to mobile device 410, for display. The advertisement payload may include product offers, coupons, and advertisements for products of interest to the consumer, based on the consumer location. In s404, the consumer clicks on an offer in the advertisement payload. Upon detecting the click by the consumer, server 430 requests, in s406, identity graph 436 to retrieve a consumer identification (CID, e.g., by using a mobile identification). With the CID, in s408 server 430 gets the offer selected by the consumer and generates, in s412, a CID offer monitor. In s414, server 430 includes the CID offer monitor to the consumer offers in the advertisement payload provided to mobile device 410. In s416, server 430 requests a payload digital code (e.g., a barcode or a QR code) from card provider 450. In s418, server 430 requests wallet application API 434 to generate files for a mobile wallet application installed and running in mobile device 410. In s420, server 430 informs mobile device 410 that the offer has been processed and entered in the system. Accordingly, when the consumer desires to apply any other offer in the advertisement payload, at any POS in any other retailer within the system, the POS will recognize the consumer and validate the offer simply by accessing the record created by server 430 on the mobile wallet application using the CID.

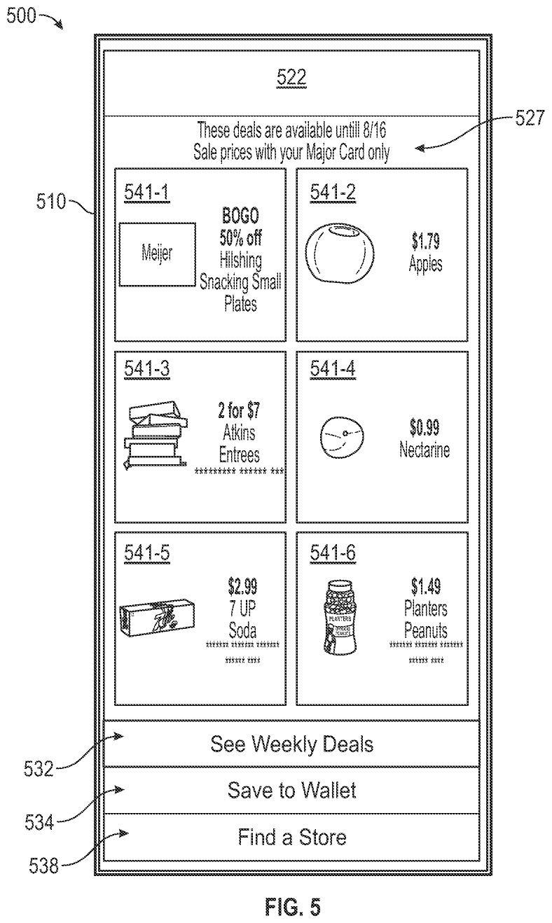

FIG. 5 illustrates a landing webpage 500 in a desktop application 522 running in a mobile device 510, to access an offer booklet 527 for a consumer, according to some embodiments. Offer booklet 527 may include three action tabs 532, 534, and 538: “see weekly deals.” (532) “save to wallet.” (534) and “find a store” (538) that the consumer may access to explore offers and locations where to redeem such offers. To access offer booklet 527, the consumer may click an advertisement from a content provider, or may in fact activate a wallet application installed in mobile device 510.

Offer booklet 527 may include offers 541-1, 541-2, 541-3, 541-4, 541-5, and 541-6 (hereinafter, collectively referred to as “offers 541”). Once the consumer clicks on one of offers 541, a sequence of actions involving a multi-digital incentive engine and an advertising engine as described herein is started (e.g., multi-digital incentive engine 230, advertising engine 240, and sequence 400).

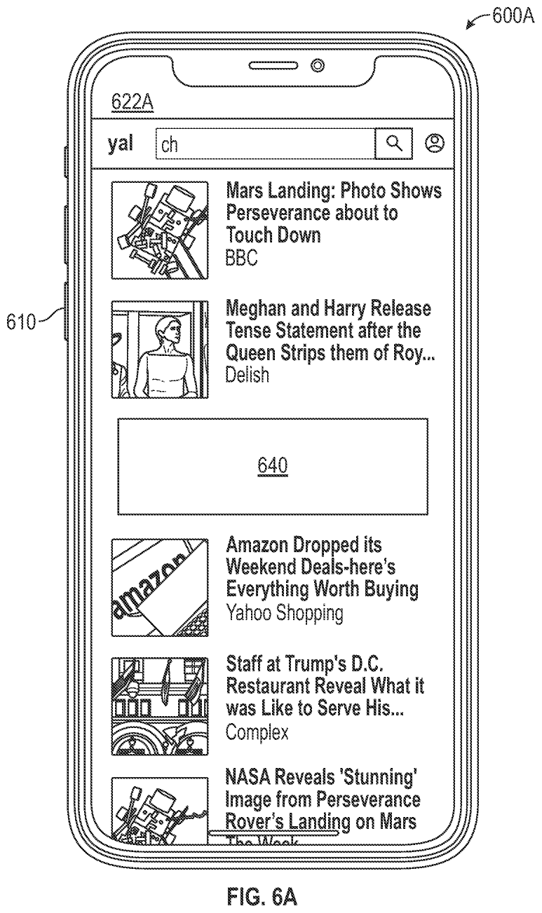

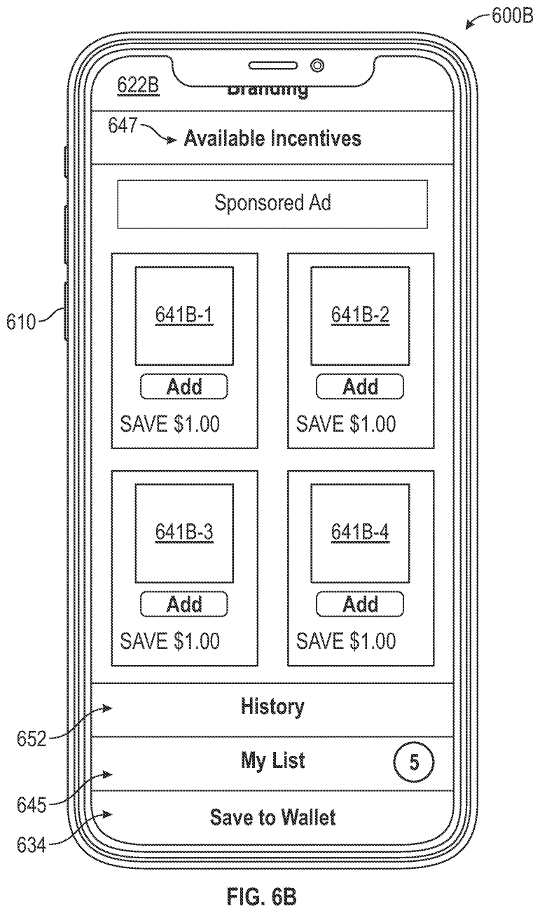

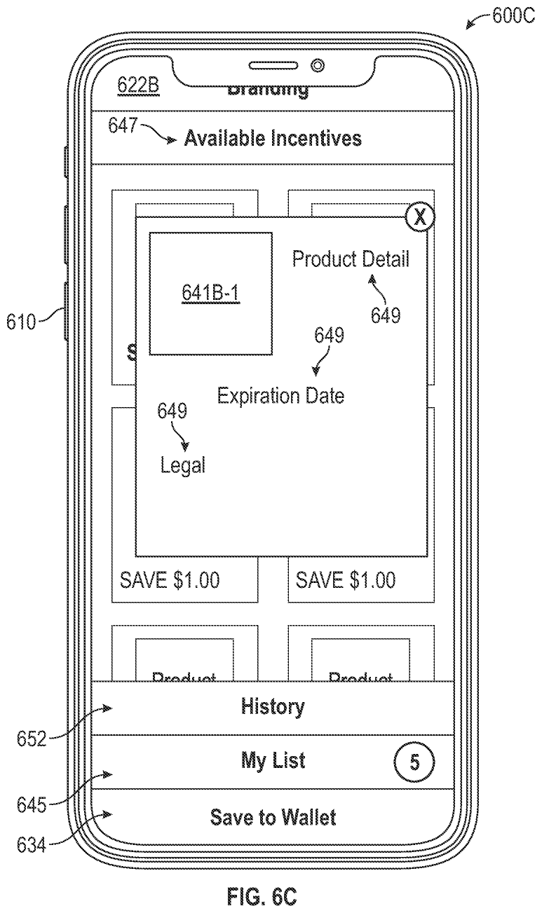

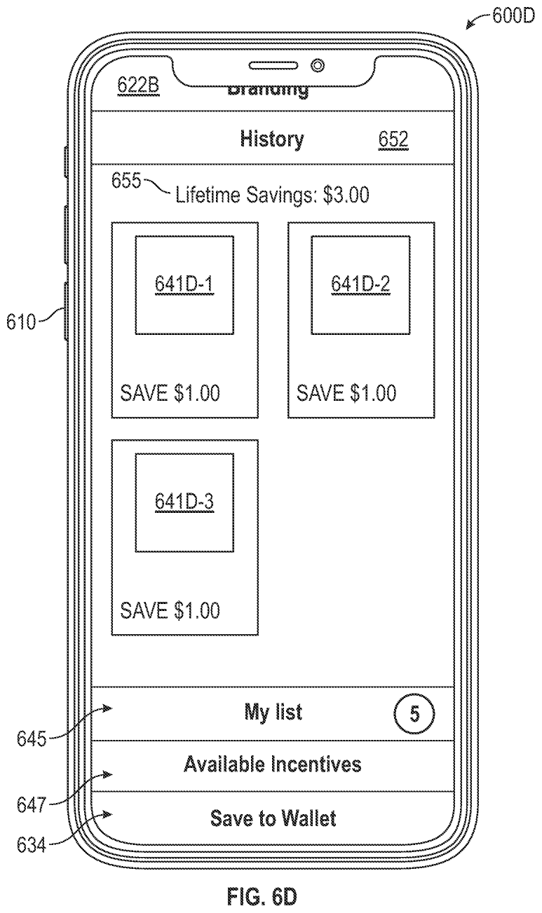

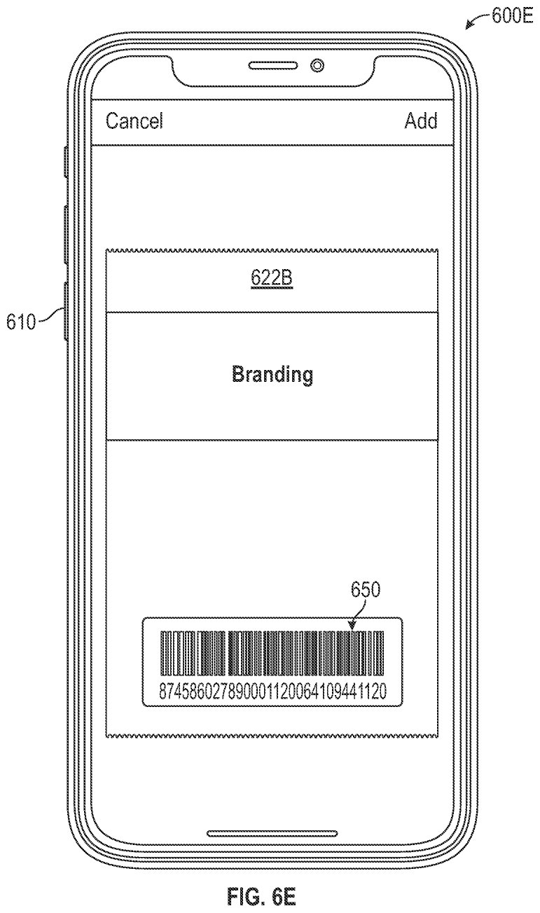

FIGS. 6A-6E illustrate different screenshots 600A, 600B, 600C, 600D, and 600E (hereinafter, collectively referred to as “screenshots 600”) in applications 622A (browser), or 622B (mobile wallet) installed in a mobile device 610 used by a consumer, according to some embodiments.

Screenshot 600A includes an advertisement 640 embedded in a webpage retrieved by browsing application 622A. Upon clicking advertisement 640, mobile wallet application 622B may be activated and display screenshot 600B.

Screenshots 600B and 600C display available incentives 647 including digital coupons 641B-1, 641B-2, 641B-3, and 641B-4 (hereinafter, collectively referred to as “coupons 641B”). Coupons 641B may include product offers, or incentives selected by a consumer from a personalized booklet accessed via mobile wallet application 622B. Mobile wallet application 622B also includes a history tab 652 where the consumer may look at past purchases and past offers and coupons 641B, and a “my list” tab 645 where the consumer may look into preferred, selected, or “clipped” coupons 641B. With a “save to wallet” tab 634, the consumer may select one or more coupons 641B to store in the wallet for future redemption. When coupons 641B are stored by mobile wallet application 622B, the consumer may redeem these at any location (e.g., and any retailer that carries the product in the respective coupon). Moreover, in some embodiments, coupons 641B are displayed in screenshot 600B based on identifying that the consumer is located within a retail store that offers the products in coupons 641B for sale, as an incentive for the consumer to make a purchase. When the consumer clicks on any one of coupons 641B, mobile wallet application 622B may display information 649 including a legal notice (e.g., applicable jurisdictions and other legal bounds and conditions—such as age restrictions for alcoholic beverages, and the like-), an expiration date, and product details.

Screenshot 600D illustrates a history 652 of redeemed coupons 641D-1, 641D-2, and 641D-3 (hereinafter, collectively referred to as “redeemed coupons 641D”). In some embodiments, screenshot 600D includes an indicator 655 showing the consumer a total saving accrued by redeemed coupons 641D.

Screenshot 600E illustrates a digital code (e.g., a barcode) 650 displayed on mobile device 610 by a mobile wallet application 622E. The consumer may scan digital code 650 at the POS to redeem one or more of coupons 641B loaded from the booklet in wallet application 622B.

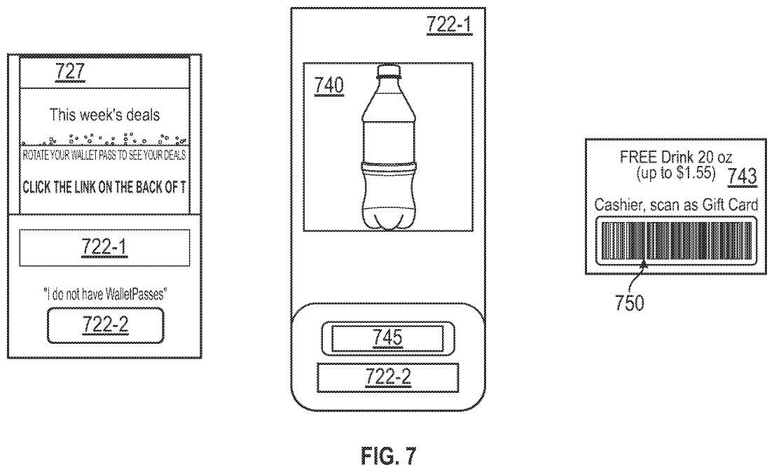

FIG. 7 illustrates a digital payload 727 selected by a consumer from a personalized booklet accessed via a mobile wallet application 722-1, according to some embodiments. The consumer may also load the offers and coupons in digital payload 727 into a digital pay application 722-2 to apply a coupon 740 on a specific product found at a retail store. Mobile wallet application 722-2 then provides a screenshot 743 that includes a digital code 750, in addition to other messages indicative of the product and the amount of the savings, and the like. The consumer may then scan digital code 750 at the POS to redeem coupon 740.

Should the user desire to access a second coupon for a different product from mobile wallet application 722-1 at a second retail store, the user would receive digital code 750 to redeem the second coupon at the second retail store. At any one of the first retail store, the second retail store or both, the consumer may use cash, credit card, or digital pay application 722-2 to purchase the product. In some embodiments, digital code 750 identifies the consumer and therefore may be the same for all coupons and offers in mobile wallet application 722-1. In some embodiments, once digital code 750 is stored securely in mobile wallet application 722-1, the consumer may simply scan the code at the POS of any retail location to redeem in the purchase of any of the products included in digital payload 727. For example, at a single retail store, the consumer may use the same digital code 750 to redeem in the purchase of multiple products (thus avoiding the need to painfully scan each coupon separately at the POS). In some embodiments, a tab 745 may direct the consumer to redeem coupon 740 at a selected retail store.

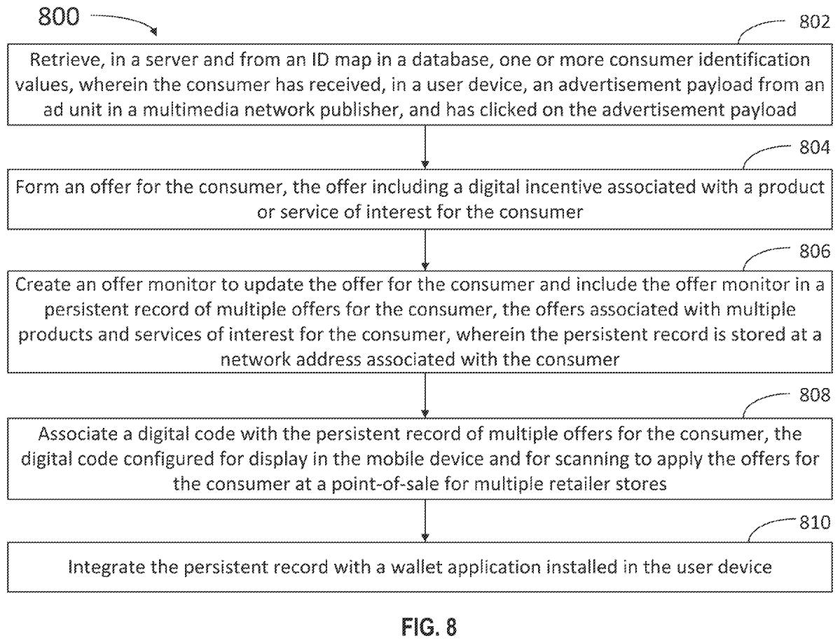

FIG. 8 is a flow chart illustrating steps in a method 800 for accessing multiple, personalized digital offers for a consumer and redeeming such offers using a single digital code, according to some embodiments. Embodiments as disclosed herein may include steps in method 800 at least partially performed by computers, servers, databases, and client devices communicatively coupled via a network, as disclosed herein (e.g., client devices 110, servers 130, databases 252, and network 150). The servers and client devices may have memory circuits storing instructions and processor circuits configured to execute the instructions to perform at least one or more of the steps in method 800 (e.g., processor circuits 212 and memory circuits 220). The memory circuits and the instructions may include an application, a multi-digital incentive engine, and an advertising engine, as disclosed herein (e.g., application 222, multi-digital incentive engine 230, and advertising engine 240). In some embodiments, the multi-digital incentive engine and the advertising engine may operate with one or more tools such as an algorithm, a mobile wallet tool, and identification tool, a location tool, a data science tool, a segment tool, and a delivery tool (e.g., algorithm 232, mobile wallet tool 234, identification tool 236, location tool 238, data science tool 242, segment tool 244, and delivery tool 246). In some embodiments, a method consistent with the present disclosure may include at least one or two of the steps in method 800 performed in any order, simultaneously, quasi-simultaneously, or overlapping in time.

Step 802 includes retrieving, in a server and from an identification graph in a database, one or more consumer identification values, wherein a consumer has received, in a user device, an advertisement payload from a multimedia network publisher, and has clicked on the advertisement payload. In some embodiments, the user device is one of a mobile device or a desktop device, and step 802 includes retrieving a network address for the mobile device or the desktop device. In some embodiments, step 802 further includes providing a passcode for the wallet application to the user device.

Step 804 includes forming digital coupons, product offers, or incentives for the consumer, the offer including a digital incentive associated with a product or service of interest for the consumer. In some embodiments, step 804 includes accessing a purchasing history for the consumer to identify a product that is likely to be purchased by the consumer. In some embodiments, step 804 includes correlating a purchasing history for the consumer with an advertising campaign of a product manufacturer or a retailer to identify an offer for a product that the consumer is likely to purchase. In some embodiments, step 804 includes selecting a deal for a product associated with the consumer.

Step 806 includes creating, in a persistent record, an offer monitor to update the offer for the consumer and include the digital coupons, product offers, or incentives, the digital coupons, product offers, or incentives associated with multiple products and services of interest for the consumer, wherein the persistent record includes multiple digital coupons, product offers, or incentives for the consumer and is stored at a network address associated with the consumer. In some embodiments, the offer monitor includes a digital trigger that is activated when the consumer views the digital coupons, product offers, or incentives using the user device, and step 806 further includes receiving, from the digital trigger activated in the user device, an indication that the consumer has clicked on the offer.

Step 808 includes associating a digital code with the persistent record, the digital code configured for display in the user device and for recognition by a POS scanner to apply at least one of the digital coupons, product offers, or incentives for the consumer at a point-of-sale in multiple retailer stores. In some embodiments, the digital code includes a barcode, pin numbers, or a quick response code configured for display by the user device, and step 808 includes forming a single barcode, pin code, or quick response code with the consumer. In some embodiments, step 808 includes using gift card redemption technology.

Step 810 includes integrating the persistent record with an operating system provided by the mobile wallet application included with the user device. In some embodiments, step 810 includes generating a script or API in the wallet application to redirect a browser to the network address associated with the consumer.

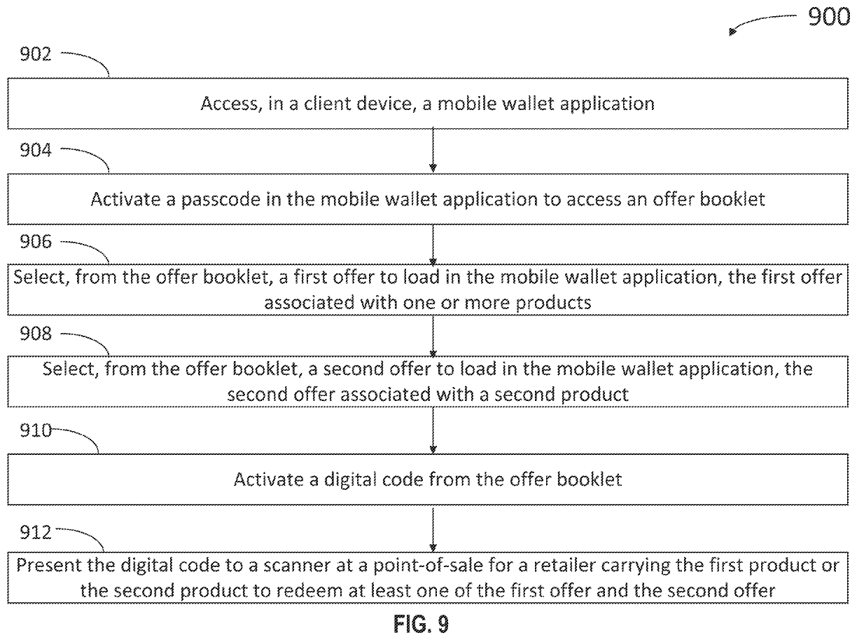

FIG. 9 is a flow chart illustrating steps in a method 900 for accessing a booklet of personalized digital coupons, product offers, and incentives for a consumer using a mobile device, according to some embodiments. Embodiments as disclosed herein may include steps in method 900 at least partially performed by computers, servers, databases, and client devices communicatively coupled via a network, as disclosed herein (e.g., client devices 110, servers 130, databases 252, and network 150). The servers and client devices may have memory circuits storing instructions and processor circuits configured to execute the instructions to perform at least one or more of the steps in method 900 (e.g., processor circuits 212 and memory circuits 220). The memory circuits and the instructions may include an application, a multi-digital incentive engine, and an advertising engine, as disclosed herein (e.g., application 222, multi-digital incentive engine 230, and advertising engine 240). In some embodiments, the multi-digital incentive engine and the advertising engine may operate with one or more tools such as an algorithm, a mobile wallet tool, and identification tool, a location tool, a data science tool, a segment tool, and a delivery tool (e.g., algorithm 232, mobile wallet tool 234, identification tool 236, location tool 238, data science tool 242, segment tool 244, and delivery tool 246). In some embodiments, a method consistent with the present disclosure may include at least one or two of the steps in method 900 performed in any order, simultaneously, quasi-simultaneously, or overlapping in time.

Step 902 includes accessing, in a client device, a mobile wallet application.

Step 904 includes activating a passcode to access an offer booklet. In some embodiments, step 904 includes providing a device identifier to a remote server handling the offer booklet.

Step 906 includes selecting, from the offer booklet, a first offer to load in the mobile wallet application, the first offer associated with one or more products.

Step 908 includes selecting, from the offer booklet, a second offer to load in the mobile wallet application, the second offer associated with a second product. In some embodiments, step 908 further includes transferring the offers from the mobile wallet application into a mobile payment application at the point-of-sale for the first retailer.

Step 910 includes activating a digital code from the offer booklet. In some embodiments, step 910 includes storing the digital code in the mobile wallet application.

Step 912 includes presenting the digital code at a point-of-sale for a first retailer carrying the first product or the second product to redeem at least one of the first offer and the second offer. In some embodiments, step 912 includes presenting the digital code for a second retailer carrying a third product to redeem a third offer for the third product from the offer booklet, wherein the third offer is loaded in the mobile wallet application.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

### Hardware Overview

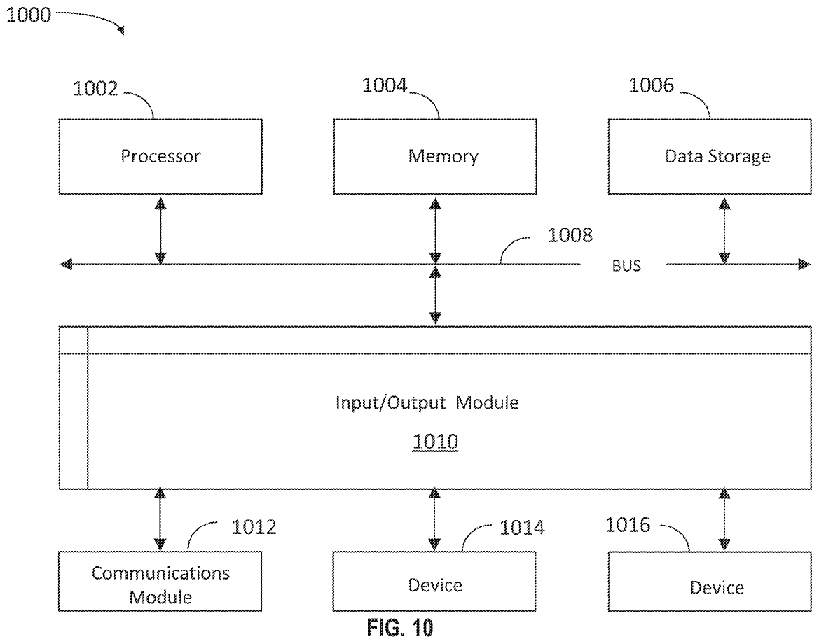

FIG. 10 is a block diagram illustrating an exemplary computer system 1000 with which the client device 110 and server 130 of FIGS. 1 and 2, and the methods of FIGS. 8 and 9 can be implemented. In certain aspects, the computer system 1000 may be implemented using hardware or a combination of software and hardware, either in a dedicated server, or integrated into another entity, or distributed across multiple entities.

Computer system 1000 (e.g., client device 110 and server 130) includes a bus 1008 or other communication mechanism for communicating information, and a processor 1002 (e.g., processors 212) coupled with bus 1008 for processing information. By way of example, the computer system 1000 may be implemented with one or more processors 1002. Processor 1002 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1000 can include, in addition to hardware, code that creates an execution environment for the computer program in question, e.g., code that constitutes processor firmware, a protocol stack, a database management system, an operating system, or a combination of one or more of them stored in an included memory 1004 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 1008 for storing information and instructions to be executed by processor 1002. The processor 1002 and the memory 1004 can be supplemented by, or incorporated in, special purpose logic circuitry.

The instructions may be stored in the memory 1004 and implemented in one or more computer program products, e.g., one or more modules of computer program instructions encoded on a computer-readable medium for execution by, or to control the operation of, the computer system 1000, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1004 may also be used for storing temporary variable or other intermediate information during execution of instructions to be executed by processor 1002.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and inter-coupled by a communication network. The processes and logic flows described in this specification can be performed by one or more programmable processors executing one or more computer programs to perform functions by operating on input data and generating output.

Computer system 1000 further includes a data storage device 1006 such as a magnetic disk or optical disk, coupled with bus 1008 for storing information and instructions. Computer system 1000 may be coupled via input/output module 1010 to various devices. Input/output module 1010 can be any input/output module. Exemplary input/output modules 1010 include data ports such as USB ports. The input/output module 1010 is configured to connect to a communications module 1012. Exemplary communications modules 1012 (e.g., communications modules 218) include networking interface cards, such as Ethernet cards and modems. In certain aspects, input/output module 1010 is configured to connect to a plurality of devices, such as an input device 1014 (e.g., input device 214) and/or an output device 1016 (e.g., output device 216). Exemplary input devices 1014 include a keyboard and a pointing device, e.g., a mouse or a trackball, by which a consumer can provide input to the computer system 1000. Other kinds of input devices 1014 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 1016 include display devices, such as an LCD (liquid crystal display) monitor, for displaying information to the consumer.

According to one aspect of the present disclosure, the client device 110 and server 130 can be implemented using a computer system 1000 in response to processor 1002 executing one or more sequences of one or more instructions contained in memory 1004. Such instructions may be read into memory 1004 from another machine-readable medium, such as data storage device 1006. Execution of the sequences of instructions contained in main memory 1004 causes processor 1002 to perform the process steps described herein. One or more processors in a multi-processing arrangement may also be employed to execute the sequences of instructions contained in memory 1004. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component. e.g., an application server, or that includes a front end component. e.g., a client computer having a graphical consumer interface or a Web browser through which a consumer can interact with an implementation of the subject matter described in this specification, or any combination of one or more such back end, middleware, or front end components. The components of the system can be inter-coupled by any form or medium of digital data communication. e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1000 can include clients and servers. A client and server are generally remote from each other and typically interact through a communication network. The relationship of client and server arises by virtue of computer programs running on the respective computers and having a client-server relationship to each other. Computer system 1000 can be, for example, and without limitation, a desktop computer, laptop computer, or tablet computer. Computer system 1000 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1002 for execution. Such a medium may take many forms, including, but not limited to, non-volatile media, volatile media, and transmission media. Non-volatile media include, for example, optical or magnetic disks, such as data storage device 1006. Volatile media include dynamic memory, such as memory 1004. Transmission media include coaxial cables, copper wire, and fiber optics, including the wires forming bus 1008. Common forms of machine-readable media include, for example, floppy disk, a flexible disk, hard disk, magnetic tape, any other magnetic medium, a CD-ROM. DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A. B, and C” or “at least one of A, B, or C” each refer to only A, only B, or only C; any combination of A, B, and C; and/or at least one of each of A. B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

### RECITATION OF EMBODIMENTS

Embodiments as disclosed herein may include any one of the following:

Embodiment I: A computer-implemented method includes retrieving, in a server and from an identification map in a database, one or more consumer identification values, wherein a consumer has received, in a user device, an advertisement payload from a multimedia network publisher, and has clicked on the advertisement payload. The computer-implemented method also includes forming an offer for the consumer, the offer including a digital incentive associated with a product or service of interest for the consumer, and creating, in a persistent record, an offer monitor to update the offer for the consumer and include the offer, the offers associated with multiple products and services of interest for the consumer, wherein the persistent record includes multiple offers for the consumer and is stored at a network address associated with the consumer. The computer-implemented method also includes associating a digital code with the persistent record, the digital code configured for display in the user device and for recognition by a scanner to apply to multiple offers for the consumer in the advertisement payload at a point-of-sale of multiple retailer stores, and integrating the persistent record with a wallet application installed in the user device.

Embodiment II: A system includes one or more processors, and a memory storing instructions which, when executed by the one or more processors, cause the system to perform operations. The operations include to retrieve, in a server and from an identification map in a database, one or more consumer identification values, wherein a consumer has received, in a user device, an advertisement payload from a multimedia network publisher, and has clicked on the advertisement payload. The operations also include to form an offer for the consumer, the offer including a digital incentive associated with a product or service of interest for the consumer, and to create, in a persistent record, an offer monitor to update the offer for the consumer and include the offer, the offers associated with multiple products and services of interest for the consumer, wherein the persistent record includes multiple offers for the consumer and is stored at a network address associated with the consumer. The operations also include to associate a digital code with the persistent record, the digital code configured for display in the user device and for recognition by a scanner to apply to multiple offers for the consumer in the advertisement payload at a point-of-sale for multiple retailer stores; and to integrate the persistent record with a wallet application installed in the user device.

Embodiment III: A computer-implemented method includes accessing, in a client device, a mobile wallet application, activating a passcode to access an offer booklet, selecting, from the offer booklet, a first offer to load in the mobile wallet application, the first offer associated with a first product, selecting, from the offer booklet, a second offer to load in the mobile wallet application, the second offer associated with a second product, activating a digital code from the offer booklet, and presenting the digital code at a point-of-sale for a first retailer carrying the first product or the second product to redeem at least one of the first offer and the second offer.

Embodiments as disclosed herein may further include the features n Embodiments I, II, and III, combined with any permutation of one or more of the following elements:

Element 1, wherein the user device is one of a mobile device or a desktop device, and retrieving the one or more consumer identification values includes retrieving a network address for the mobile device or the desktop device. Element 2, wherein retrieving one or more consumer identification values further includes providing a passcode for the wallet application to the user device. Element 3, wherein the offer monitor includes a digital trigger that is activated when the consumer views the offer using the user device, the method further including receiving, from the digital trigger activated in the user device, an indication that the consumer has clicked on the offer. Element 4, wherein the digital code includes a barcode or a quick response code configured for display by the user device, and associating the digital code with the persistent record includes forming a single barcode or quick response code with the consumer. Element 5, wherein associating the digital code includes using gift card technology. Element 6, wherein integrating the persistent record with the wallet application includes generating a script in the wallet application to redirect a browser to the network address associated with the consumer. Element 7, wherein forming an offer to the consumer includes accessing a purchasing history for the consumer to identify a product that is likely to be purchased by the consumer. Element 8, wherein forming an offer to the consumer includes correlating a purchasing history for the consumer with an advertising campaign of a product manufacturer or a retailer to identify an offer for a product that the consumer is likely to purchase. Element 9, wherein forming an offer to the consumer includes selecting a deal for a product associated with the consumer.

Element 10, wherein the user device is one of a mobile device or a desktop device, and to retrieve the one or more consumer identification values the one or more processors execute instructions to retrieve a network address for the mobile device or the desktop device. Element 11, wherein to retrieve one or more consumer identification values the one or more processors execute instructions to retrieve a passcode for the wallet application to the user device. Element 12, wherein the offer monitor includes a digital trigger that is activated when the consumer views the offer using the user device, and the one or more processors further execute instructions to receive, from the digital trigger activated in the user device, an indication that the consumer has clicked on the offer. Element 13, wherein the digital code includes a barcode or a quick response code configured for display by the user device, and to associate the digital code with the persistent record the one or more processors execute instructions to form a single barcode or quick response code with the consumer.

Element 14, wherein activating a passcode to access the offer booklet includes providing a device identifier to a remote serve handling the offer booklet. Element 15, further including transferring the offers from the mobile wallet application into a mobile payment application at the point-of-sale for the first retailer. Element 16, further including storing the digital code in the mobile wallet application. Element 17, further including presenting the digital code for a second retailer carrying a third product to redeem a third offer for the third product from the offer booklet, wherein the third offer is loaded in the mobile wallet application.

1. A computer-implemented method, comprising:
retrieving, in a server and from an identification map in a database, one or more consumer identification values, wherein a consumer has received, in a user device, an advertisement payload from a multimedia network publisher, and has clicked on the advertisement payload;
forming an offer for the consumer, the offer including a digital incentive associated with a product or service of interest for the consumer;
creating, in a persistent record, an offer monitor to update the offer for the consumer and include the offer, the offers associated with multiple products and services of interest for the consumer, wherein the persistent record includes multiple offers for the consumer and is stored at a network address associated with the consumer;
associating a digital code with the persistent record, the digital code configured for display in the user device and for recognition by a scanner to apply to multiple offers for the consumer in the advertisement payload at a point-of-sale of multiple retailer stores; and
integrating the persistent record with a wallet application installed in the user device.

2. The computer-implemented method of claim 1, wherein the user device is one of a mobile device or a desktop device, and retrieving the one or more consumer identification values includes retrieving a network address for the mobile device or the desktop device.

3. The computer-implemented method of claim 1, wherein retrieving one or more consumer identification values further includes providing a passcode for the wallet application to the user device.

4. The computer-implemented method of claim 1, wherein the offer monitor includes a digital trigger that is activated when the consumer views the offer using the user device, the method further including receiving, from the digital trigger activated in the user device, an indication that the consumer has clicked on the offer.

5. The computer-implemented method of claim 1, wherein the digital code includes a barcode or a quick response code configured for display by the user device, and associating the digital code with the persistent record includes forming a single barcode or quick response code with the consumer.

6. The computer-implemented method of claim 1, wherein associating the digital code includes using gift card technology.

7. The computer-implemented method of claim 1, wherein integrating the persistent record with the wallet application includes generating a script in the wallet application to redirect a browser to the network address associated with the consumer.

8. The computer-implemented method of claim 1, wherein forming an offer to the consumer includes accessing a purchasing history for the consumer to identify a product that is likely to be purchased by the consumer.

9. The computer-implemented method of claim 1, wherein forming an offer to the consumer includes correlating a purchasing history for the consumer with an advertising campaign of a product manufacturer or a retailer to identify an offer for a product that the consumer is likely to purchase.

10. The computer-implemented method of claim 1, wherein forming an offer to the consumer includes selecting a deal for a product associated with the consumer.

11. A system, comprising:
one or more processors; and
a memory storing instructions which, when executed by the one or more processors, cause the system to perform operations, comprising to:
retrieve, in a server and from an identification map in a database, one or more consumer identification values, wherein a consumer has received, in a user device, an advertisement payload from a multimedia network publisher, and has clicked on the advertisement payload;
form an offer for the consumer, the offer including a digital incentive associated with a product or service of interest for the consumer;
create, in a persistent record, an offer monitor to update the offer for the consumer and include the offer, the offers associated with multiple products and services of interest for the consumer, wherein the persistent record includes multiple offers for the consumer and is stored at a network address associated with the consumer;
associate a digital code with the persistent record, the digital code configured for display in the user device and for recognition by a scanner to apply to multiple offers for the consumer in the advertisement payload at a point-of-sale for multiple retailer stores; and
integrate the persistent record with a wallet application installed in the user device.

12. The system of claim 11, wherein the user device is one of a mobile device or a desktop device, and to retrieve the one or more consumer identification values the one or more processors execute instructions to retrieve a network address for the mobile device or the desktop device.

13. The system of claim 11, wherein to retrieve one or more consumer identification values the one or more processors execute instructions to retrieve a passcode for the wallet application to the user device.

14. The system of claim 11, wherein the offer monitor includes a digital trigger that is activated when the consumer views the offer using the user device, and the one or more processors further execute instructions to receive, from the digital trigger activated in the user device, an indication that the consumer has clicked on the offer.

15. The system of claim 11, wherein the digital code includes a barcode or a quick response code configured for display by the user device, and to associate the digital code with the persistent record the one or more processors execute instructions to form a single barcode or quick response code with the consumer.

16. A computer-implemented method, comprising:
accessing, in a client device, a mobile wallet application;
activating a passcode to access an offer booklet;
selecting, from the offer booklet, a first offer to load in the mobile wallet application, the first offer associated with a first product;
selecting, from the offer booklet, a second offer to load in the mobile wallet application, the second offer associated with a second product;
activating a digital code from the offer booklet; and
presenting the digital code at a point-of-sale for a first retailer carrying the first product or the second product to redeem at least one of the first offer and the second offer.

17. The computer-implemented method of claim 16, wherein activating a passcode to access the offer booklet comprises providing a device identifier to a remote serve handling the offer booklet.

18. The computer-implemented method of claim 16, further comprising presenting the digital code for a second retailer carrying a third product to redeem a third offer for the third product from the offer booklet, wherein the third offer is loaded in the mobile wallet application.

19. The computer-implemented method of claim 16, further comprising transferring the offers from the mobile wallet application into a mobile payment application at the point-of-sale for the first retailer.

20. The computer-implemented method of claim 16, further comprising storing the digital code in the mobile wallet application.
